(19) United States
(12) Patent Application Publication
(10) Pub. No.: US 2021/0233184 A1
(43) Pub. Date: Jul. 29, 2021

(54) SYSTEM AND METHOD FOR ANALYZING AGRICULTURAL DATA

(71) Applicant: 365FarmNet Group KGaA mbH & Co. KG, Harsewinkel (DE)

(72) Inventors: Marten Grundmann, Berlin (DE); Stephan Poppe-Kirchmann, Lüdinghausen (DE)

(73) Assignee: 365FarmNet Group KGaA mbH & Co. KG, Harsewinkel (DE)

(21) Appl. No.: 17/159,747

(22) Filed: Jan. 27, 2021

(30) Foreign Application Priority Data
Jan. 29, 2020 (DE) 102020102149.6

(51) Int. Cl. G06Q 50/02; G06Q 30/02; G06Q 10/10; G06Q 10/06; G06F 21/62; G06F 16/903

(52) U.S. Cl. CPC G06Q 50/02; G06Q 30/0201; G06Q 30/0205; G06F 16/90335; G06Q 10/06393; G06Q 10/06312; G06F 21/6254; G06Q 10/103

(57) ABSTRACT

A method and apparatus for analyzing agricultural data using an analytical tool of a server program is disclosed. The server platform includes a receiving tool that continuously receives personalized raw data on agricultural work processes, with the raw data including usage data and business data from a plurality of agricultural data sources. An analyst can present an analytical query to the analytical tool, with the analytical query comprises analytical parameters. The analytical tool, based on the analytical parameters, selects part of the raw data, anonymizes it, and aggregates it into status data based on the analytical parameters. The status data relate to a current agricultural status of an area of agricultural production, which the analytical tool may provide to the analyst.

### CROSS REFERENCE TO RELATED APPLICATION

This application claims priority under 35 U.S.C. § 119 to German Patent Application No. DE 102020102149.6 (filed Jan. 29, 2020), the entire disclosure of which is hereby incorporated by reference herein.

### TECHNICAL FIELD

The invention relates to a system and method for analyzing agricultural data using an analytical tool of a server platform.

### BACKGROUND

In modern agriculture, data-based analysis is used more prevalently in agriculture. For example, WO 2011/019453 A1 discloses collecting agricultural data in an agricultural context. In this way, the collected agricultural data may be available to the farmer.

### DESCRIPTION OF THE FIGURE

The present application is further described in the detailed description which follows, in reference to the noted plurality of drawings by way of non-limiting examples of exemplary implementation, in which like reference numerals represent similar parts throughout the several views of the drawings, and wherein:

FIG. 1 shows a schematic representation of a method for analyzing agricultural data in an agricultural context.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

As discussed in the background, collected agricultural data may be made available to the farmer. However, providing the collected agricultural data only to farmers is limiting. Rather, other parties involved or associated with agriculture may likewise benefit from access to and analysis of the collected agricultural data. For example, agriculture currently involves agricultural businesses complex biochemical factories in which a very wide range of influences interact, for example from seed, herbicides, agricultural machines, and human decisions. These biochemical factories are also dependent on their regional and super-regional context. Accordingly, the environmental influences on various agricultural businesses within a geographic region are frequently similar. This would therefore make it possible to achieve greater efficiency given corresponding access to the collected agricultural data since a user may also analyze data from adjacent users and not only his or her own data. It is however problematic that the user does not have any access to this data.

Other analysts in the agricultural sector may also draw important conclusions about micro and macro-relationships in the biochemical factories of agricultural businesses by analyzing this technical data. Accordingly, a supplier of fertilizers may improve or optimize his/her warehousing if he/she would have insight into the specific conditions of the biochemical agricultural factories in his/her surroundings. Likewise, the problem is that the supplier does not have this insight.

Thus, in one or some embodiments, a method for analyzing agricultural data is disclosed that permits improved access to the technical data of the agricultural businesses taking into account the private sphere of individual users.

The underlying agricultural data are already stored digitally on one or more server platforms. Thus, in one or some embodiments, the one or more server platforms may be used to anonymize and aggregate the data. In this way, it is possible to offer various analysts the option of defining and processing their own analyses of these databases without requiring access to the raw data.

In one or some embodiments, a method is disclosed for analyzing agricultural data using an analytical tool of a server program, wherein the server platform has a receiving tool that is configured to receive (such as continuously receive) personalized raw data on agricultural work processes comprising usage data and business data from a plurality of agricultural data sources. In an analytical routine, an analyst may pose an analytical query to the analytical tool, wherein the analytical query comprises one or more analytical parameters. In turn, the analytical tool may select part of the raw data defined or dictated by the analytical parameters in an aggregation routine, may anonymize part or all of the selected raw data, and may aggregate part or all of the anonymized raw data into status data based on the analytical parameters. The status data may relate to a current agricultural status of an area of agricultural production, with the analytical tool providing the status data to the analyst.

In one or some embodiments, the analytical parameters may relate to any one, any combination, or all of: an agricultural resource (e.g., an herbicide); an agricultural piece of equipment (e.g., an agricultural production machine); an agricultural work process(es) (e.g., an agricultural work process that relates to agricultural chemistry); seed; agricultural technology; animal health; or analytical parameters comprising boundary conditions for selecting the raw data.

In one or some embodiments, the agricultural work processes may relate to the use of the resources and/or equipment, the status data may comprise usage data of the resources and/or equipment, and/or the business data may comprise data on an agricultural business assigned to an agricultural user (e.g., production machine data).

In one or some embodiments, the data sources may relate to several agricultural users, with different data sources being assigned to a particular user. For example, a first user may have access through the server platform to the data sources assigned to the first user (e.g., all of the raw data from all of the data sources are assigned to the first user), and a second user does not have access through the server platform to all the data sources assigned to the first user (e.g., the second user is assigned a subset of the raw data assigned to the first user). In this regard, the data sources may relate to several agricultural users who do not have any access among themselves to data sources assigned to another user.

In one or some embodiments, the data sources may comprise any one, any combination, or all of: sensors of agricultural production machines (e.g., agricultural vehicles); documentation routines performed by the users with a documentation tool of the server platform; or user-independent data sources (e.g., weather data sources). Accordingly, particularly relevant agricultural data may be depicted.

In one or some embodiments, the raw data may comprise data (such as real-time raw data) that were generated within a specific time period, such as a month, a week, or a day before posing the analytical query. In this way, the analyst may analyze a current status of the technical system “agricultural business” promptly and currently.

In one or some embodiments, the server platform has a real-time database, and at least part of the agricultural data sources send real-time raw data several times (such as continuously) to the real-time database, with the analytical tool aggregating part or all of the sent real-time raw data in the aggregation routine into the status data. In this way, the real-time data may be analyzed.

In one or some embodiments, a user may obtain access to the status data of other users in anonymized and aggregated form. In particular, the user may be allowed to compare his/her own data with a benchmark comprising (or consisting of) data from other users. To achieve this, a benchmarking tool of the server platform may be used to generate benchmarking data from the raw data, with the benchmarking tool comparing the raw data from the user to the benchmarking data (e.g., the benchmarking tool may provide one or more proposals to the user, such as a reduction of the use of the agricultural resources and/or equipment based on the comparison of agricultural measures, thereby improving the work processes of the user (such as improvement with respect to use).

In one or some embodiments, the analytical query is a market analysis query which can give others who are not users, such as analysts, access to the status data. In particular, the analytical query may relate to a trend of use of the resources and/or equipment in a current agricultural period, such that the status data comprise usage trend data and localization data linked to the usage trend data.

In one or some embodiments, some of the data for the analytical query may be collected that were initially triggered by this analytical query. For example, in the documentation routine, a user may document agricultural work processes using a documentation tool of the server platform by inputting the raw data (e.g., such that in the documentation routine, the documentation tool offers the user questions (such as initial documentation questions) to be answered, and the user answers the questions, and whereby further questions may be generated and/or adapted based on the answers to the initial documentation questions). One example of a documentation tool is disclosed in U.S. Application No. ______ entitled “SYSTEM AND METHOD FOR PROCESS-RELATED GENERATION OF AGRICULTURAL DATA” (attorney docket number 15191-20010A (P05281/8)), incorporated by reference herein in its entirety.

In one or some embodiments, the agricultural data sources comprise sensors assigned to various users. For example, the agricultural data sources may comprise sensors that are assigned to different users, such as sensors of agricultural production machines, such that the status data comprise real-time sensor data generated by the sensors.

In one or some embodiments, the analyst may receive an analytical result that is updated in an analytical environment of the server platform (such as regularly or periodically updated by the server platform on the basis of or in response to receiving real-time raw data). For example, the server platform may provide the analyst with an analytical environment, through which the analyst may provide the analytical query, thereby providing regular updates of the status data and/or an analytical result based on the status data.

In one or some embodiments, a method is disclosed for the improved or optimized provision of agricultural resources and/or equipment by the analyst using the status data. Reference is made to all statements regarding the disclosed method, such as the use of the status data. In particular, the analyst may provide (such as automatically provide) agricultural resources and/or equipment for a user based on the status data.

In one or some embodiments, a server platform is disclosed which is designed for use with the disclosed method. Reference is made to all statements regarding the disclosed method.

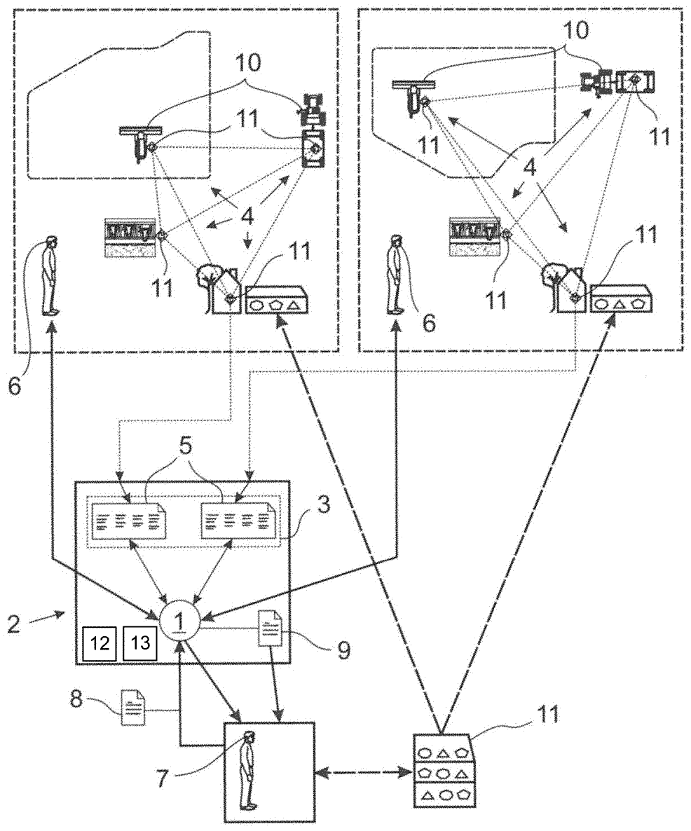

Referring to the FIGURE, FIG. 1 schematically shows the disclosed method for analyzing agricultural data by an analytical tool 1 of a server platform 2. In this context, the agricultural data may relate to widely different technical aspects of an agricultural business. Merely by way of example, the agricultural data may generally relate to animal husbandry and/or field cultivation. In particular, the agricultural data may relate to feeding a specific animal and/or harvesting a specific plant. Other examples are noted below.

The server platform 2 may include one or more electronic devices, such as one or more servers and one or more mobile electronic devices. The various tools discussed herein may be embodied or incorporated into the one or more electronic devices. As merely one example, the analytical tool 1 may be incorporated into one or more servers (e.g., a server sitting on the Internet). Thus, the server platform 2 may comprise one or more servers and one or more computer programs, and need not be restricted to one location. The server platform 2 at least comprises a hardware component that runs a computer program. In particular, the server platform 2 may include one or more processors and one or more memories (for storing executable computer programs and/or data, such as raw data 5). For purposes of illustration, server platform 2 may include the one or more processors, such as processor 12, and the one or more memories, such as memory 13. Though processor 12 (which may comprise a microprocessor, controller, PLA or the like) and memory 13 are depicted as separate elements, they may be part of a single machine, which includes a microprocessor (or other type of controller) and a memory unit. Further, various elements depicted in FIG. 1 may include a processor and a memory. As merely one example, analytical tool 1 may include a processor and a memory separate from processor 12 and memory 13. Alternatively, analytical tool 1 may access processor 12 and memory 13 to perform its dsiclosed functionality.

The microprocessor and memory unit are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry, such as processor 12, may store in or access instructions from memory 13 for execution, or may implement its functionality in hardware alone. The instructions, which may comprise computer-readable instructions, may implement the functionality described herein and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described herein or illustrated in the drawings. Thus, server platform 2 (including analytical tool 1), using the processor 12 and the memory 13, may perform any one, any combination, or all of the funtionality discussed herein.

Thus, in principle, the server platform 2 may comprise a computer and/or a mobile device. Accordingly, for example, part of a computer program of the server platform 2 may be installed on the computer. In principle, a decentralized embodiment of the server platform 2 is also contemplated. For communication with a user, the server platform 2 may comprise at least one input device and at least one output device, such as the computer, or is connected thereto, at least temporarily. Further, the server platform may include communication functionality, such as wired and/or wireless communication functionality (e.g., cellular and/or Internet communication), in which to communication with other electronic devices (e.g., to receive data and/or to send communications in order to cause an output).

The server platform 2 has a receiving tool 3 that is configured to receive (such as continuously or periodically receive) personalized raw data 5 on agricultural work processes from a plurality of agricultural data sources 4. In one or some embodiments, the receiving tool receives raw data, such as receiving continuously or periodically personalized raw data 5, on agricultural work processes from a plurality of agricultural data sources 4. Similar to the agricultural data, the agricultural work processes may relate to widely differing agricultural jobs. The personalized raw data 5 may comprise usage data and/or business data which are assigned, or may be assigned, to a certain agricultural user 6. The usage data may relate to the use of particular agricultural resources and/or particular equipment, whereas the business data may relate to more general data, such as the presence and/or the type of resources and/or equipment.

In an analytical routine, an analyst 7 may pose an analytical query 8 to the analytical tool 1. The analytical query 8 may relate to different aspects of the agricultural work processes. Broadly, the analytical query 8 may relate to the agricultural data and may be answered using the raw data 5. Merely by way of example, the analytical query 8 may relate to the consumption of a fertilizer or an herbicide in the environment of a supplier. The analytical query 8 may comprise one or more analytical parameters. In the example of the query relating to the consumption of the fertilizer, an analytical parameter may then correspondingly relate to a time period in which the consumption of the fertilizer is to be analyzed.

In an aggregation routine, the analytical tool 1 may select a part of the raw data 5 defined by the analytical parameters, may anonymize some or all of the selected part, and may aggregate some or all of this anonymized part of the raw data 5 into status data 9 based on the analytical parameters. Generally speaking, the term “aggregate” may be understood broadly. More specifically, the term “aggregate” may relate to collecting or gathering the raw data 5 and/or may include removing complexity from the raw data 5. During anonymization, personal data may be removed from the raw data 5, thus ensuring that no inferences to the specific user 6 are possible from the status data 9.

In one or some embodiments, the status data 9 relate to a current agricultural status of an area of agricultural production, with the analytical tool 1 providing the status data 9 to the user 6 and/or the analyst 7. Various manner of providing the status data are contemplated, such as displaying and/or rendering the status data 9 useful for further analyses. Further, various areas of agricultural production are contemplated, such as animal husbandry and cultivation. The status may be, for example, a general status of animal husbandry, or a specific status, for example, of an animal as well.

The raw data 5 may be provided continuously by the agricultural data sources 4. To achieve this, at least one of the agricultural data sources 4 may regularly provide raw data 5. However, it is unnecessary for the raw data 5 to be provided free of interruption. In one or some embodiments, the analytical routine and the aggregation routine run sequentially. Alternatively, the analytical routine and the aggregation routine may run interwoven or interdependent with each other. Merely by way of example, the analyst 7 may define a part of the analytical parameters, then the part of raw data 5 may selected (based on the part of the analytical parameters defined) and anonymized, and then additional analytical parameters may be defined by the analyst 7. This may be performed iteratively or several times based on the same part of the raw data 5, and then the part of the raw data 5 is aggregated into the status data 9.

In one or some embodiments, the analytical parameters may serve to select the part of the raw data 5 used to answer the analytical query 8. The analytical parameters may relate to an agricultural resource, such as an herbicide and/or a piece of agricultural equipment (e.g., an agricultural production machine 10). Resources may include the means that have a direct influence on an agricultural yield (e.g., consumables), and equipment may include those means that are very generally required for the agricultural business. The agricultural work processes may relate to any one, any combination, or all of the following areas: agricultural chemistry; seed; agricultural technology; or animal health. In one or some embodiments, the analytical parameters may comprise boundary conditions for selecting the raw data 5. Various boundary conditions are contemplated. As discussed in more detail below, boundary conditions may comprise any one, any combination, or all of the following: an upper limit; a lower limit; or a characteristic/trait (not associated with any upper limit or lower limit). One example of such a boundary condition would be that only data from agricultural businesses are sought that use a fertilizer from a particular fertilizer manufacturer or a particular fertilizer supplier. Thus, the boundary condition may comprise a value of a tag associated with the raw data (e.g., fertilizer manufacturer tag =fertilizer manufacturer X), with the boundary condition being used to select the raw data 5 that has the value of the tag specified (e.g., raw data 5 that has a value of fertilizer manufacturer X for the fertilizer manufacturer tag). In this way, the analytical parameters may define one or more aspects that enable the selection of a subset of the raw data 5 (e.g., the boundary conditions may comprise an upper limit and/or a lower limit; the boundary conditions may comprise a value of a tag or the like associated with the raw data).

The work processes may relate to the use of the resources and/or equipment. In addition or alternatively, the status data 9 may comprise usage data of the resource and/or equipment. The business data may comprise data on an agricultural business assigned to an agricultural user 6, such as production machine data. FIG. 1 shows, for example, two agricultural businesses with agricultural users 6. The analyst 7 in this case is, for example, a supplier of fertilizer. In order to optimize the amount of fertilizer in his or her warehouse, the supplier may seek data on how much fertilizer will be used in the two agricultural businesses. The use of fertilizers in businesses that he or she does not supply is contrastingly irrelevant in this case. The supplier may therefore seek direct insight into the processes of the biochemical factory of “agricultural business” which are provided to the supplier by the disclosed methodology.

In one or some embodiments, the data sources 4 may relate to several agricultural users 6. Different data sources 4 may be assigned to different users 6, as shown in FIG. 1. Merely by way of example, a first user of the users 6 has access through the server platform 2 to the data sources 4 assigned to the first user of the users 6 and the complete raw data 5 from the data sources 4 assigned to the first user of the users 6. A second user of the users 6 does not have access through the server platform 2 to the data sources 4 assigned to the first user of the users 6 (and therefore does not have access to complete raw data 5 from the data sources 4 assigned to the first user of the users 6). In one or some embodiments, most of the users 6 do not have access to the data sources 4 and the raw data 5 of the other users 6. This may mean that at least 50% of the users 6 do not have access to the data sources 4 and the raw data 5 of at least 50% of the other users 6. More specifically, this percentage can be 75%, or even more 95%. However, it may be provided, for example in the context of cooperation between users 6, that at least some of the users 6 have at least partial access to the data sources 4 and/or the raw data 5 of at least some other users 6.

In one or some embodiments, the data sources 4 comprise sensors 11 of agricultural production machines 10, such as agricultural vehicles. It is accordingly contemplated to collect current and precise data, such as automatically. In addition or alternatively, the data sources 4 may comprise documentation routines performed by the users 6 with a documentation tool of the server platform 2. In this case, it may, for example, be the documentation of the spreading of an herbicide by the user 6. In many locations, this documentation is already required from a legal perspective and therefore may easily be used as a data source 4. Alternatively, or in addition, the data sources 4 may comprise user-independent data sources 4, such as weather data sources such as a weather satellite.

The raw data 5 may comprise data that were generated within a specific time period, such as a month, a week, a day before the analytical query 8 was posed or submitted. In addition or alternatively, the raw data 5 may comprise real-time raw data. In particular, by using the real-time raw data, the supplier may plan, for example, the daily or even hourly inventory of the warehouse. Real-time raw data may also be advantageous for other analysts 7. The term “real-time” in this context is to be interpreted broadly and may include the data that were generated within a given time period before posing the analytical query (e.g., no more than one-half hour before posing the analytical query 8; no more than a few seconds before posing the analytical query 8; no more than 30 seconds before posing the analytical query 8; no more than a few fractions of a second before posing the analytical query 8; or no more than one-half second before posing the analytical query 8).

The server platform 2 may include a real-time database, with at least part of the agricultural data sources 4 sending real-time raw data multiple times, such as continuously, to the real-time database, with the analytical tool 1 aggregating them in the aggregation routine into the status data 9. This may be advantageous when, as explained below, an analytical result may be updated several times, such as continuously.

In one or some embodiments, a user 6 may comprise the analyst 7. Even if the user 6 has access to his own data, the user 6 generally does not have access to data of another user 6. In this case, the server platform 2 may include a benchmarking tool that generates benchmarking data from the raw data 5. In one or some embodiments, the benchmarking tool may compare the raw data 5 of a user 6 to the benchmarking data. Further, the benchmarking tool may propose to the user 6 in particular a reduction of the use of the agricultural resources and/or equipment based on the comparison of agricultural measures for improving the work processes of the user 6, such as with respect to use. For example, these benchmarking data may contain an analysis of the yield on the basis of fertilizer consumption and inform the user 6 that he/she is using more fertilizer than necessary and suggest using less fertilizer.

The analytical query 8 may also be a market analysis query that relates to a trend of use of the resources and/or equipment in a current agricultural period. The agricultural period may, for example, be a harvesting period, an individual day, or the like. This market analysis query may also originate from the previously mentioned supplier of a fertilizer. In one or some embodiments, the status data 9 may comprise usage trend data and localization data linked to the usage trend data. The localization data may, for example, refer to a certain region in the surroundings of the supplier.

With regard to the previously discussed documentation routine, a user 6 may document agricultural work processes using a documentation tool of the server platform 2 by inputting the raw data 5. In one or some embodiments, the documentation tool may offer or output to the user 6 questions to be answered. These questions may be specifically intended to ascertain certain raw data 5. In response to the questions, the user 6 may answer the questions. In one or some embodiments, the questions may be generated and/or adapted based on the analytical query 8. It is therefore contemplated to ascertain data not yet available for the analytical queries 8 by querying the user 6.

As previously mentioned, the agricultural data sources 4 may comprise sensors 11. In such a case, these sensors 11 may be assigned to different users 6. In particular, the sensors 11 may comprise sensors 11 of agricultural production machines 10. Further, the status data 9 may comprise real-time sensor data from the sensors 11.

To assist the analyst 7, the server platform 2 may provide the analyst 7 with an analytical environment in which the analyst 7 may pose the analytical query 8. In one or some embodiments, the status data 9 and/or an analytical result based on the status data 9 may be regularly updated by the server platform 2 on the basis of the real-time raw data. Inter alia, this has the advantage that the analyst 7 need not regularly repeat the analytical query 8. Alternatively, or in addition, the analytical result may be automatically updated given the occurrence of a predefined event, such as the receipt of certain raw data 5 (e.g., raw data tagged with certain values).

In one or some embodiments, a method is disclosed for the improved or optimized provision of agricultural resources and/or equipment by the analyst 7 using the status data 9. According to this additional teaching, the analyst 7 may provide agricultural resources and/or equipment for a user 6, such as automatically provide, based on the status data 9. This additional teaching elaborates in particular the already mentioned example of the supplier. In particular, if the supplier possesses the status data 9, he/she may automatically and promptly reorder fertilizer himself/herself and provide it to the user 6. Reference is made to all statements regarding the disclosed methodology. In particular, reference is made to all statements regarding the status data 9.

In one or some embodiments, a server platform 2 per se may also be configured for use in the disclosed methodology. Reference is made to all statements regarding the disclosed methodology. In this case, the server platform 2 may comprises at least one server and at least one computer program. The computer program may embody part or all of the disclosed methodology. In this case, the server platform 2 may include a receiving tool 3 and an analytical tool 1.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Analytical tool

2 Server platform

3 Receiving tool

4 Agricultural data source

5 Raw data

6 User

7 Analyst

8 Analytical query

9 Status data

10 Sensor

11 Agricultural production machine

12 Processor

13 Memory

1. A method for analyzing agricultural data using an analytical tool of a server platform, the method comprising:
continuously or periodically receiving, by a receiving tool of the server platform, personalized raw data on an agricultural work processes from a plurality of data sources, the personalized raw data comprising one or both of usage data or business data;
posing, by an analyst, an analytical query to the analytical tool in an analytical routine, wherein the analytical query comprises one or more analytical parameters;
selecting, by the analytical tool, at least part of the raw data based on one or more analytical parameters in an aggregation routine;
anonymizing, by the analytical tool, at least a part of the selected raw data;
aggregating, by the analytical tool, at least a part of the anonymized raw data into status data based on the analytical parameters, wherein the status data relate to a current agricultural status of an area of agricultural production; and
outputting, by the analytical tool, at least a part of the status data to the analyst for use by the analyst in at least one agricultural work process.

2. The method of claim 1, wherein the analytical parameters relate to any one, any combination, or all of: an agricultural resource; an agricultural piece of equipment; or the agricultural work processes.

3. The method of claim 2, wherein the agricultural work processes relate to use of one or both of the resources or equipment;
wherein the status data comprise usage data of the one or both of the resources or equipment; and
wherein the business data comprise data on an agricultural business assigned to an agricultural user.

4. The method of claim 1, wherein the data sources relate to a plurality of agricultural users;
wherein a first set of data sources are assigned to a first user so that raw data from the first set of data sources is assigned to the first user; and
wherein a second set of data sources are assigned to a second user, with the second set being different from the first set such that the second user is not assigned all of the raw data from the first set of data sources that is assigned to the first user.

5. The method of claim 1, wherein the plurality of data sources comprise:
sensors of agricultural production machines;
documentation routines performed by users with a documentation tool of the server platform; and
one or more user-independent data sources, the one or more user-independent data sources comprising weather data sources.

6. The method of claim 1, wherein the raw data comprise data that were generated within a specific time period before posing the analytical query; and
wherein the raw data comprise real-time raw data.

7. The method of claim 1, wherein the server platform includes a real-time database;
wherein at least some of the plurality of data sources send real-time raw data continuously to the real-time database; and
wherein the analytical tool aggregates the real-time raw data in the aggregation routine into the status data.

8. The method of claim 1, further comprising:
generating benchmarking data, using a benchmarking tool of the server platform, from the raw data;
comparing, using the benchmarking tool, the raw data from a user to the benchmarking data; and
proposing, by the benchmarking tool, to the user a reduction of use of one or both of agricultural resources or equipment based on the comparison in order to improve the agricultural work processes of the user.

9. The method of claim 1, wherein the analytical query is a market analysis query that relates to a trend of use of agricultural resources and equipment in a current agricultural period, such that the status data comprise usage trend data and localization data linked to the usage trend data.

10. The method of claim 1, wherein a user documents agricultural work processes using a documentation tool of the server platform by inputting the raw data;
wherein the documentation tool provides questions to the user to be answered;
wherein the user answers the questions in order to input the raw data; and
wherein the questions are generated or adapted based on the analytical query.

11. The method of claim 1, wherein the plurality of data sources comprise sensors of agricultural production machines assigned to different users; and
wherein the status data comprise real-time sensor data of the sensors.

12. The method of claim 1, wherein the raw data comprises real-time raw data;
wherein the server platform provides the analyst with an analytical environment; and
wherein the analyst submits the analytical query via the analytical environment, such that the status data and an analytical result based on the status data is periodically updated by the server platform on the basis of the real-time raw data.

13. The method of claim 1, wherein the analyst automatically provides one or both of agricultural resources or equipment for a user based on the status data.

14. A server platform comprising:
communication functionality configured to continuously or periodically receive personalized raw data on an agricultural work processes from a plurality of data sources, the personalized raw data comprising one or both of usage data or business data;
at least one memory to store the raw data;
at least one processor in communication with the communication functionality and the memory, the processor configured to:
receive, from an analyst via an analytical routine, an analytical query, wherein the analytical query comprises one or more analytical parameters;
select at least part of the raw data based on one or more analytical parameters in an aggregation routine;
anonymize at least a part of the selected raw data;
aggregate at least a part of the anonymized raw data into status data based on the analytical parameters, wherein the status data relate to a current agricultural status of an area of agricultural production; and
cause output of at least a part of the status data to the analyst for use by the analyst in at least one agricultural work process.

15. The server platform of claim 14, wherein the plurality of data sources comprise:
sensors of agricultural production machines;
documentation routines performed by users with a documentation tool of the server platform; and
one or more user-independent data sources, the one or more user-independent data sources comprising weather data sources.

16. The server platform of claim 14, wherein the raw data comprise data that were generated within a specific time period before posing the analytical query; and
wherein the raw data comprise real-time raw data.

17. The server platform of claim 14, wherein the memory includes a real-time database;
wherein the communication functionality to configured to receive from at least some of the plurality of data sources real-time raw data continuously for storage in the real-time database; and
wherein the processor is configured to aggregate the real-time raw data into the status data.

18. The server platform of claim 14, wherein the processor is further configured to:
generate benchmarking data from the raw data;
compare the raw data from a user to the benchmarking data; and
propose to the user a reduction of use of one or both of agricultural resources or equipment based on the comparison in order to improve the agricultural work processes of the user.

19. The server platform of claim 14, wherein the processor is further configured to:
document, via inputting the raw data from a user, agricultural work processes by inputting the raw data;
provide at least one question to the user to be answered; and
generate or adapt one or more further questions based on a user answer to the at least one question.

20. The server platform of claim 14, wherein the plurality of data sources comprise sensors of agricultural production machines assigned to different users; and
wherein the status data comprise real-time sensor data of the sensors.
